(19) United States
(12) Patent Application Publication
(10) Pub. No.: US 2016/0011076 A1
(43) Pub. Date: Jan. 14, 2016

(54) METHOD, COMPUTER PROGRAM PRODUCT & SYSTEM

(71) Applicant: AKTIEBOLAGET SKF, Göteborg (SE)

(72) Inventors: Keith HAMILTON, Dunfermline, Fife (GB); Brian MURRAY, Aberdeenshire, Aberdeen (GB)

(21) Appl. No.: 14/395,506

(22) PCT Filed: Mar. 27, 2013
(86) PCT No.: PCT/EP2013/056495

§ 371 Date: Oct. 20, 2014

Related U.S. Application Data
(60) Provisional application No. 61/637,523, filed on Apr. 24, 2012.
(60) Provisional application No. 61/637,568, filed on Apr. 24, 2012.

(51) Int. Cl. G01M 13/04

(52) U.S. Cl. CPC G01M 13/04; G01M 13/045

(57) ABSTRACT

A method for monitoring a bearing comprising the step of obtaining data concerning one or more of the factors that influence the residual life of the bearing using at least one sensor, such as a load sensor. The at least one sensor comprises an acoustic emission sensor and a temperature sensor. The method also comprises the steps of obtaining identification data uniquely identifying the bearing, transmitting data to and/or from the at least one sensor, using an industrial wireless protocol, and recording the data concerning one or more of the factors that influence the residual life of the bearing and the identification data as recorded data in a database.

### CROSS REFERENCE TO RELATED APPLICATIONS

This is a National Stage application claiming the benefit of International Application Number PCT/EP2013/056495 filed on 27 Mar. 2013 (27.03.2013), which claims the benefit of U.S. Provisional Patent Application No. 61/637,523 filed on 24 Apr. 2012 (24.04.2013) and U.S. Provisional Patent Application No. 61/637,568 filed on 24 Apr. 2012 (24.04.2012), both of which are incorporated herein by reference in their entireties.

### TECHNICAL FIELD

The present invention concerns a method, system and computer program product for monitoring a bearing.

### BACKGROUND OF THE INVENTION

Bearings are often used in critical applications, wherein their failure in service would result in significant commercial loss to the end-user. It is therefore important to be able to predict the residual life of a bearing, in order to plan intervention in a way that avoids failure in service, while minimizing the losses that may arise from taking the machinery in question out of service to replace the bearing.

The residual life of a rolling-element bearing is generally determined by fatigue of the operating surfaces as a result of repeated stresses in operational use. Fatigue failure of a rolling element bearing results from progressive flaking or pitting of the surfaces of the rolling elements and of the surfaces of the corresponding bearing races. The flaking and pitting may cause seizure of one or more of the rolling elements, which in turn may generate excessive heat, pressure and friction.

Bearings are selected for a specific application on the basis of a calculated or predicted residual life expectancy compatible with the expected type of service in the application in which they will be used. The length of a bearing's residual life can be predicted from the nominal operating conditions considering speed, load carried, lubrication conditions, etc. For example, a so-called “L-10 life” is the life expectancy in hours during which at least 90% of a specific group of bearings under specific load conditions will still be in service. However, this type of life prediction is considered inadequate for the purpose of maintenance planning for several reasons.

One reason is that the actual operation conditions may be quite different from the nominal conditions. Another reason is that a bearing's residual life may be radically compromised by short-duration events or unplanned events, such as overloads, lubrication failures, installation errors, etc. Yet another reason is that, even if nominal operating conditions are accurately reproduced in service, the inherently random character of the fatigue process may give rise to large statistical variations in the actual residual life of substantially identical bearings.

In order to improve maintenance planning, it is common practice to monitor the values of physical quantities related to vibrations and temperature to which a bearing is subjected in operational use, so as to be able to detect the first signs of impending failure. This monitoring is often referred to as “condition monitoring”.

Condition monitoring brings various benefits. A first benefit is that a user is warned of deterioration in the condition of the bearing in a controlled way, thus minimizing the commercial impact. A second benefit is that condition monitoring helps to identify poor installation or poor operating practices, e.g., misalignment, imbalance, high vibration, etc., which will reduce the residual life of the bearing if left uncorrected.

European patent application publication EP 1 164 550 describes an example of a condition monitoring system for monitoring statuses, such as the presence or absence of an abnormality in a machine component such as a bearing.

### SUMMARY OF THE INVENTION

An object of the invention is to provide an improved method for monitoring a bearing.

This object is achieved by a method comprising the steps of obtaining data concerning one or more of the factors that influence the residual life of the bearing using at least one sensor comprising an acoustic emission (AE) sensor and a temperature sensor, obtaining identification data uniquely identifying the bearing, transmitting data to and/or from the at least one sensor using an industrial wireless protocol, and recording the data concerning one or more of the factors that influence the residual life of the bearing and the identification data as recorded data in a database. According to an embodiment of the invention the at least one sensor also comprises a load sensor.

Such a method may be used to provide an early warning of degraded lubrication conditions which may lead to bearing damage, and/or of vibration that may indicate macroscopic damage to the bearing's raceway surface (caused by imbalance, misalignment, impacting, fatiguing or friction for example) and/or of temperature that may indicate the final stages of failure leading up to seizure of the bearing.

According to an embodiment of the invention the industrial wireless protocol is based on IEE802.15.4. IEE802.15.4 is a standard which specifies the physical layer and media access control for low-rate wireless personal area networks (LR-WPANs). It is maintained by the Institute of Electrical and Electronics Engineers (IEEE) 802.15 working group.

According to an embodiment of the invention the at least one sensor is attached to an inner ring or an outer ring of said bearing.

According to an embodiment of the invention the step of obtaining data concerning one or more of the factors that influence the residual life of a bearing is carried out during at least part of one of the following periods: during the bearing's manufacture, after the bearing's manufacture and before the bearing's use, during the bearing's use, during a period when the bearing is not in use, during the transportation of the bearing.

According to another embodiment of the invention the data concerning one or more of the factors that influence the residual life of the bearing includes data concerning the magnitude and/or severity of at least one of the following: vibration, temperature, rolling contact force/stress, high frequency stress waves, lubricant condition, rolling surface damage, operating speed, load carried, lubrication conditions, humidity, exposure to moisture or ionic fluids, exposure to mechanical shocks, corrosion, fatigue damage, wear.

According to a further embodiment of the invention the step of obtaining the identification data includes obtaining the identification data from a machine-readable identifier associated with the bearing.

According to an embodiment of the invention electronic means is used in the step of recording the data in a database.

According to a further embodiment of the invention the method comprises the step of predicting the residual life of the bearing (i.e. for predicting when it is necessary or desirable to service, replace or refurbish (re-manufacture) the bearing) using said recorded data and a mathematical residual life predication model. Such a method allows a quantitative prediction of the residual life of a bearing to me made on the basis of information providing a comprehensive view of the bearing's history and usage. Data concerning one or more of the factors that influence the residual life of a bearing is accumulated and the bearing's history log is then used with a mathematical residual life prediction model to predict the residual life thereof at any point in its life-cycle. The residual life prediction may be updated at any subsequent point in its life cycle as more data is accumulated.

According to a further embodiment of the invention t the method comprises the step of changing one or more parameters of a mathematical residual life predication model used to predict the residual life of the bearing or changing the mathematical residual life predication model selection used to predict the residual life of the bearing. The same bearing may be assessed with respect to different life-cycle models at different times during its residual life. For example, the life-cycle model used before and after a bearing's refurbishment may be different, if the application in which it is used is different. Changing models is no problem as the complete history of the bearing is known and accessible under the bearing's unique identification data.

According to an embodiment of the invention the bearing is a rolling element bearing. The rolling bearing may be any one of a cylindrical roller bearing, a spherical roller bearing, a toroidal roller bearing, a taper roller bearing, a conical roller bearing or a needle roller bearing.

The present invention also concerns a computer program product that comprises a computer program containing computer program code means arranged to cause a computer or a processor to execute the steps of a method according to any of the embodiments of the invention stored on a computer-readable medium or a carrier wave.

The present invention further concerns a system for monitoring a bearing comprising at least one sensor configured to obtain data concerning one or more of the factors that influence the residual life of the bearing. The system also comprises at least one identification sensor comprising an acoustic emission sensor and a temperature sensor configured to obtain identification data uniquely identifying the bearing, transmission means configured to transmit data to and/or from the at least one sensor using an industrial wireless protocol, and a data processing unit configured to record the data concerning one or more of the factors that influence the residual life of the bearing, and the identification data as recorded data in a database. According to an embodiment of the invention the at least one sensor also comprises a load sensor.

According to an embodiment of the invention the industrial wireless protocol is based on IEE802.15.4

According to another embodiment of the invention the at least one sensor is attached to an inner ring or an outer ring of the bearing.

According to an embodiment of the invention the at least one sensor configured to obtain data concerning one or more of the factors that influence the residual life of a bearing is configured to obtain the data during at least part of one of the following periods: during the bearing's manufacture, after the bearing's manufacture and before the bearing's use, during the bearing's use, during a period when the bearing is not in use, during the transportation of the bearing. A complete history log of a bearing may thereby be created. Accordingly, as a result of having residual life data accumulated over the bearing's life, starting with its very manufacturing all the way up to the present, a more accurate prediction can be made regarding the residual life of the individual bearing at any point in its life-cycle. Depending on the specific mathematical life-cycle model applied, the end-user is notified of relevant facts including the time at which it is advisable to replace or refurbish the bearing.

According to another embodiment of the invention the data concerning one or more of the factors that influence the residual life of the bearing includes data concerning the magnitude and/or severity of at least one of the following: vibration, temperature, rolling contact force/stress, high frequency stress waves, lubricant condition, rolling surface damage, operating speed, load carried, lubrication conditions, humidity, exposure to moisture or ionic fluids, exposure to mechanical shocks, corrosion, fatigue damage, wear.

According to a further embodiment of the invention the at least one identification sensor includes a reader configured to obtain the identification data from a machine-readable identifier associated with the bearing. A machine-readable identifier may be applied to a bearing during its manufacture.

According to an embodiment of the invention the data processing unit is configured to record the data electronically.

According to another embodiment of the invention the system comprises a prediction unit configured to predict the residual life of the bearing using the recorded data and a mathematical residual life predication model.

According to a further embodiment of the invention the prediction unit is configured to update the residual life prediction using the mathematical residual life predication model and new data concerning one or more of the factors that influence the residual life of a bearing and/or concerning one or more similar or substantially identical bearings as the new data is obtained by the at least one sensor and/or recorded by the data processing unit.

According to an embodiment of the invention the bearing is a rolling element bearing. The rolling bearing may be any one of a cylindrical roller bearing, a spherical roller bearing, a toroidal roller bearing, a taper roller bearing, a conical roller bearing or a needle roller bearing.

The method, system and computer program product according to the present invention may be used to monitor the residual life of at least one bearing used in automotive, aerospace, railroad, mining, wind, marine, metal producing and other machine applications which require high wear resistance and/or increased fatigue and tensile strength.

### BRIEF DESCRIPTION OF THE DRAWINGS

The present invention will hereinafter be further explained by means of non-limiting examples with reference to the appended figures where;

FIG. 1 shows a system according to an embodiment of the invention,

FIG. 2 is a flow diagram showing the steps of a method according to an embodiment of the invention, and

FIG. 3 shows a rolling element bearing, the residual life of which can be predicted using a system or method according to an embodiment of the invention.

It should be noted that the drawings have not been drawn to scale and that the dimensions of certain features have been exaggerated for the sake of clarity.

Furthermore, any feature of one embodiment of the invention can be combined with any other feature of any other embodiment of the invention as long as there is no conflict.

### DETAILED DESCRIPTION OF EMBODIMENTS

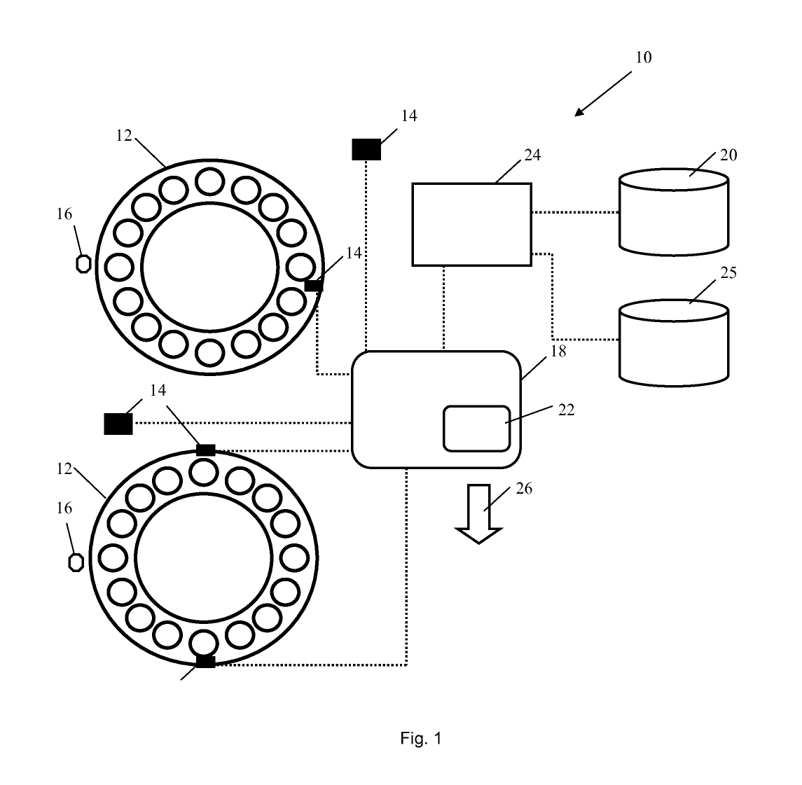

FIG. 1 shows a system 10 for monitoring a plurality of bearings 12 during their use. The illustrated embodiment shows two rolling element bearings 12, the system 10 according to the present invention may however be used to predict the residual life of one or more bearings 12 of any type, and not necessarily all of the same type or size. The system 10 comprises a plurality of sensors 14 comprising an acoustic emission sensor and a temperature sensor, and optionally a load sensor configured to obtain data concerning one or more of the factors that influence the residual life of each bearing 12. At least one sensor 14 may be integrated with a bearing 12, it may be attached to inner ring or the outer rings of a bearing or to the bearing housing, it may be placed in the vicinity of the bearing 12 or remotely from the bearing. Data from one bearing 12 may be obtained automatically using one or more sensors 14.

Rolling contact forces may for example be recorded by a strain sensor of a load sensor 14 located on an outer surface or side of the bearing's outer ring, or on an inner surface or inner side of the bearing's inner ring. Such a strain sensor may be of the resistance, piezoelectric, piezoresistive or microelectromechanical systems (MEMS) type or use the stretching of an optical fibre embedded within the bearing 12.

A sensor 14 may be embedded in the bearing ring or attached externally to the bearing housing to monitor a lubricant condition. Lubricant can be degraded by contamination in several ways. For example, a lubricant film may fail to protect a bearing 12 against corrosion, either because of its water content or the entrainment of corrosive materials, e.g., acid, salt, etc. As another example, a lubricant film may be contaminated with solid material that has an abrasive effect on the bearing's raceway. A lubrication film can also be compromised by excessive load, low viscosity of the lubricant or contamination of the lubricant with particulate material, or a lack of lubricant. The condition of the lubrication film can be assessed by detecting high-frequency stress waves that propagate through the bearing rings and the surrounding structure in the event of a breakdown of the lubrication film.

High frequency stress waves accompany the sudden displacement of small amounts of material in a very short period of time. In bearings high frequency stress waves can be generated when impacting, fatigue cracking, scuffing or abrasive wear occurs. An absolute motion sensor, such as an accelerometer, an acoustic emission sensor, or an ultrasonic sensor can be used to detect such high frequency stress waves and thereby provide important information for assistance in fault detection and severity assessment. Due to the dispersion and attenuation of the high frequency stress wave packet, it is desirable to locate a sensor as near to the initiation site as possible. A sensor may therefore be placed in the vicinity of, or on the bearing housing, preferably in the load zone.

Furthermore, a lubrication film can be compromised by excessive load, low viscosity of the lubricant or contamination of the lubricant with particulate material, or a lack of lubricant. If a lubrication film is compromised in this way, high frequency waves will be emitted by rolling contact of the bearing. The condition of the lubrication film can therefore be assessed by detecting high-frequency stress waves that propagate through the bearing rings and the surrounding structure in the event of a breakdown of the lubrication film.

The system 10 also comprises at least one identification sensor configured to obtain identification data 16 uniquely identifying each bearing 12. The identification data 16 may be obtained from a machine-readable identifier associated with a bearing 12, and is preferably provided on the bearing 12 itself so that it remains with the bearing 12 even if the bearing 12 is removed to a different location or if the bearing 12 is refurbished. Examples of such machine-readable identifiers are markings that are engraved, glued, physically integrated, or otherwise fixed to a bearing, or a pattern of protrusions or of other deformations located on the bearing. Such identifiers may be mechanically, optically, electronically, or otherwise readable by a machine. The identification data 16 may for example be a serial number or an electronic device, such as a Radio Frequency Identification (RFID) tag, securely attached to the bearing 12. The RFID tag's circuitry may receive its power from incident electromagnetic radiation generated by an external source, such as the data processing unit 18 or another device (not shown) controlled by the data processing unit 18.

The at least one data processing unit 18 optionally pre-processes identification data 16 and the signals received from the sensors 14. The signals may be converted, re-formatted or otherwise processed so as to generate service life data representative of the magnitudes sensed. The at least one data processing unit 18 may for example be configured to use data reduction methodology. For example, a digital time waveform may be captured by each sensor and transformed into the frequency domain via a fast Fourier Transform (FFT) analysis. In addition to spectral analysis, the transforming of the time waveform into an autocorrelation function may provide great assistance in diagnostics, Autocorrelation allows an analyst to determine the dominant periodic events within a stress wave analysis waveform. In doing so a waveform can be cleaned up allowing an analyst to see which sources are the main contributors to such waveforms.

Data is transmitted to and/or from the at least one sensor 14 using an industrial wireless protocol. Data may be transferred between sensors 14 and/or between a sensor and another component of the system 10, such as the data processing unit 18, a database 20, or a component external to the system 10.

If an appropriate wireless communication protocol such as that described in IEEE802.15.4 is employed, a new bearing installed on site will announce its presence and software developed for the purpose will communicate its unique digital identity. Appropriate database functionality then associates that identity and location with the previous history of that bearing.

Such identification data 16 enables an end-user or a supplier of a bearing 12 to verify if a particular bearing is a genuine article or a counterfeit product. Illegal manufacturers of bearings may for example try to deceive end-users or Original Equipment Manufacturers (OEMs) by supplying bearings of inferior quality, in packages with a false trademark, so as to give the impression that the bearings are genuine products from a trustworthy source. Worn bearings may be refurbished and then sold without an indication that they have been refurbished and old bearings may be cleaned and polished and sold without the buyer knowing the actual age of the bearings. However, if a bearing is given a false identity, a check of a database of the system according to the present invention may reveal a discrepancy. For example, the identity of a counterfeit product will not exist in the database, or the residual life data obtained under its identification data will not be consistent with the false bearing being checked. The database of the system according to the present invention indicates for each legitimate bearing, its age and whether or not the bearing has been refurbished. Thus, the system according to the present invention facilitates the authentication of a bearing.

The system 10 comprises at least one data processing unit 18 configured to electronically record the data concerning one or more of the factors that influence the residual life of each bearing 12 and the identification data 16 as recorded data in a database 20.

The database 20 may be maintained by the manufacturer of the bearings 12. Thus, each bearing 12 of a batch of similar or substantially identical bearings 12 can be tracked. The residual life data gathered in the database 20 for a whole batch of bearings 12 enables the manufacturer to extract further information, e.g., about relationships between types or environments of usage versus rates of change of residual life, so as to further improve the service to the end-user.

The database 20 may contain data obtained from at least one sensor 14 obtained during the period after manufacture of the bearing and during the transportation of the bearing 14. At least one sensor 14 (not necessarily the same at least one sensor 14 that is utilized when the bearing 12 is in use) may register the magnitudes of the forces, the type and concentration of chemicals, the level of moisture etc. to which the bearing is subjected during this period.

The system also optionally comprises a prediction unit 22 configured to predict the residual life of each bearing 12 using the recorded data and a mathematical residual life predication model.

It should be noted that not all of the components of the system 10 necessarily need to be located in the vicinity of the bearings 12. The components of the system 10 may communicate by wired or wireless means, or a combination thereof, and be located in any suitable location. For example, databases containing the recorded data 20 and a plurality of mathematical residual life predication models 25 may located at a remote location and communicate with at least one data processing unit 18 located in the same or a different place to the bearings 12 by means of a server 24 for example.

The at least one data processing unit 18 optionally pre-processes the identification data 16 and the signals received from the sensors 14. The signals may be converted, re-formatted or otherwise processed so as to generate service life data representative of the magnitudes sensed. The at least one data processing unit 18 may be arranged to communicate the identification data 16 and the residual life data via a communication network, such as a telecommunications network or the Internet for example. A server 24 may log the data in a database 20 in association with the identification data 16, thus building a history of the bearing 12 by means of accumulating service life data over time.

It should be noted that the at least one data processing unit 18, the prediction unit 22 and/or the database 20 need not necessarily be separate units but may be combined in any suitable manner. For example a personal computer may be used to carry out a method concerning the present invention.

The sensors 14 are configured to obtain data concerning one or more of the factors that influence the residual life of a bearing 12. For example, the sensors 14 may be configured to obtain data concerning the magnitude and/or severity of at least one of the following: vibration, temperature, rolling contact force/stress, high frequency stress waves, lubricant condition, rolling surface damage, operating speed, load carried, lubrication conditions, humidity, exposure to moisture or ionic fluids, exposure to mechanical shocks, corrosion, fatigue damage, wear.

The sensors 14 may be configured to obtain data during at least part of one of the following periods: during the bearing's manufacture, after the bearing's manufacture and before the bearing's use, during the bearing's use, during a period when the bearing is not in use, during the transportation of the bearing. Data may be obtained periodically, substantially continuously, randomly, on request, or at any suitable time. Furthermore, a data processing unit 18 may obtain data concerning one or more of the factors that influence the residual life of a bearing 12 from a source other than one of the system's sensors 14, from a user or the bearing's manufacturer for example.

A complete history log of a bearing may thereby be created. Accordingly, as a result of having residual life data accumulated over the bearing's life, starting with its very manufacturing all the way up to the present, a more accurate prediction can be made regarding the residual life of the individual bearing at any point in its life-cycle. Depending on the specific mathematical life-cycle model applied, the end-user is notified of relevant facts including the time at which it is advisable to replace or refurbish the bearing.

According to an embodiment of the invention a prediction unit 22 may be configured to predict the residual life of a bearing 12 or a type of bearing, using data concerning one or more similar or substantially identical bearings 12, for example using data collected from a plurality of bearings, such as recordings made over an extended period of time and/or based on tests on similar or substantially identical bearings. An average residual lifetime for a bearing 12 or a type of bearing may thereby be obtained.

A prediction unit 22 may be configured to update a residual life prediction using a mathematical residual life predication model and new data concerning one or more of the factors that influence the residual life of a bearing 12 and/or concerning one or more similar or substantially identical bearings 12 as the new data is obtained by the at least one sensor 14 and/or recorded by the data processing unit 18. Such updates may be made periodically, substantially continuously, randomly on request or at any suitable time.

The system 10 may be arranged to select a particular mathematical residual life predication model from a plurality of mathematical residual life predication models, stored in a database 25 for example, on the basis of the data 16 uniquely identifying the bearing 12. A prediction unit 22 may additionally, or alternatively be configured to receive input concerning at least one of the following: one or more parameters of a mathematical residual life predication model, a mathematical residual life predication model selection from a user or another prediction unit for example.

Once a bearing condition assessment or prediction 26 of the residual life of a bearing 12 has been made, it may be displayed on a user interface, and/or sent to a user, bearing manufacturer, database and/or another prediction unit 22. Notification of a bearing condition and/or of when it is advisable to service, replace or refurbish one or more bearings 12 being monitored by the system 10 may be made in any suitable manner, such as via a communication network, via an e-mail or telephone call, a letter, facsimile, alarm signal, or a visiting representative of the manufacturer.

The bearing condition assessment or prediction 26 of the residual life of a bearing 12 may be used to inform a user of when he/she should replace the bearing 12. Intervention to replace the bearing 12 is justified, when the cost of intervention (including labour, material and loss of, for example, plant output) is justified by the reduction in the risk cost implicit in continued operation. The risk cost may be calculated as the product of the probability of failure in service on the one hand, and the financial penalty arising from such failure in service, on the other hand.

According to an embodiment of the invention the system may be arranged to obtain data concerning the actual residual life of a bearing 12 from a user for example, and to send this data to a mathematical residual life prediction model developer together with the prediction 26 of the residual life of a bearing 12 so that improvements or changes to a mathematical residual life prediction model may be made.

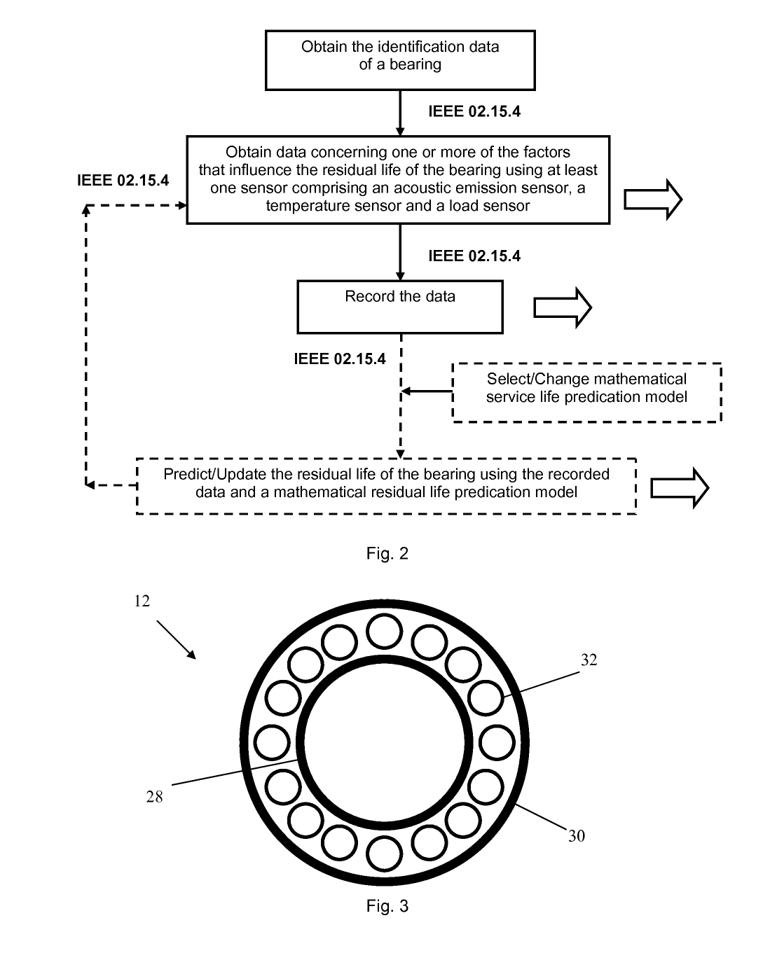

FIG. 2 shows the steps of a method according to an embodiment of the invention. The method comprises the steps of obtaining identification data uniquely identifying a bearing, obtaining data concerning one or more of the factors that influence the residual life of a bearing using at least one sensor comprising an acoustic emission sensor, a temperature sensor and a load sensor, recording this data and optionally predicting the residual life of the bearing using the recorded data and a mathematical residual life predication model. Data is transmitted to and/or from at least one sensor obtaining data concerning one or more of the factors that influence the residual life of a bearing and/or identification data using an industrial wireless protocol, based on IEE802.15.4 for example. The data obtained by the at least one sensor, the identification data, recorded data and/or a residual life prediction may also be communicated to any other component of the system or outside a system, to a user and/or a bearing manufacturer using an industrial wireless protocol, based on IEE802.15.4 for example.

It should be noted that the steps need not necessarily be carried out in the order shown in FIG. 2, but may be carried out in any suitable order. For example, identification data may be recorded before any data concerning one or more of the factors that influence the residual life of the bearing is obtained and/or stored. The mathematical residual life predication model used to make a prediction of the residual life of the bearing may be selected or changed and a predication may be updated at any suitable time.

FIG. 3 schematically shows an example of bearing 12 that can be monitored using a system or method according to an embodiment of the invention. FIG. 3 shows a rolling element bearing 12 comprising an inner ring 28, an outer ring 30 and a set of rolling elements 32. The inner ring 28 and/or outer ring 30 of a bearing 12 that can be monitored using a system or method according to an embodiment of the invention, may be of any size and have any load-carrying capacity. An inner ring 28 and/or an outer ring 30 may for example have a diameter up to a few metres and a load-carrying capacity up to many thousands of tonnes.

Further modifications of the invention within the scope of the claims would be apparent to a skilled person. Even though the claims are directed to a method, system and computer program product for monitoring a bearing, such a method, system and computer program may be used for monitoring some other component of rotating machinery such as a gear wheel.

1. A method for monitoring a bearing comprising the step of:
obtaining data concerning one or more factors that influence the residual life of said bearing using at least one sensor,
wherein said at least one sensor, comprises an acoustic emission sensor and a temperature sensor, and said method also comprises the steps of:
obtaining identification data uniquely identifying said bearing,
transmitting data at least one of to and from the at least one sensor using an industrial wireless protocol, and
recording said data concerning one or more of the factors that influence the residual life of said bearing and said identification data as recorded data in a database.

2. A method according to claim 1, wherein said at least one sensor also comprises a load sensor.

3. A method according to claim 1, wherein said industrial wireless protocol is based on IEE802.15.4

4. A method according to claim 1, wherein said at least one sensor, is attached to one of an inner ring or an outer ring of said bearing.

5. A method according to claim 1, wherein said step of obtaining data concerning one or more factors that influence the residual life of a bearing is carried out during at least part of one of the following periods: during said bearing's manufacture, after said bearing's manufacture and before said bearing's use, during said bearing's use, during a period when the bearing is not in use, during the transportation of said bearing.

6. A method according to claim 1, wherein said data concerning one or more factors that influence the residual life of said bearing includes data concerning at least one of the magnitude and severity of at least one of the following: vibration, temperature, rolling contact force/stress, high frequency stress waves, lubricant condition, rolling surface damage, operating speed, load carried, lubrication conditions, humidity, exposure to moisture, exposure to ionic fluids, exposure to mechanical shocks, corrosion, fatigue damage, and wear.

7. A method according to claim 1, wherein said step of obtaining said identification data includes obtaining said identification data from a machine-readable identifier associated with said bearing.

8. A method according to claim 1, wherein an electronic data recording device is used in said step of recording said data in a database.

9. A method according to claim 1, wherein said method further comprises a step of predicting the residual life of said bearing using said recorded data and a mathematical residual life predication model.

10. A method according to claim 1, wherein said bearing is a rolling element bearing.

11. A computer program product, comprising a computer program containing computer program code arranged to cause one of a computer or a processor to execute steps of a method, wherein the steps comprise:
obtaining data concerning one or more factors that influence the residual life of said bearing using at least one sensor,
wherein said at least one sensor, comprises an acoustic emission sensor and a temperature sensor, and said method also comprises the steps of:
obtaining identification data uniquely identifying said bearing,
transmitting data at least one of to and from the at least one sensor using an industrial wireless protocol, and
recording said data concerning one or more factors that influence the residual life of said bearing and said identification data as recorded data in a database,
wherein the computer program code is stored on one of a computer-readable medium or a carrier wave.

12. A system for monitoring a bearing comprising:
at least one sensor configured to obtain data concerning one or more factors that influence the residual life of said bearing,
wherein said at least one sensor comprises an acoustic emission sensor and a temperature sensor and said system also comprises:
at least one identification sensor configured to obtain identification data uniquely identifying said bearing,
transmission means configured to transmit data at least one of to and from the at least one sensor using an industrial wireless protocol, and
a data processing unit configured to record said data concerning one or more factors that influence the residual life of said bearing, and said identification data as recorded data in a database.

13. A method according to claim 12, wherein said at least one sensor also comprises a load sensor.

14. A system according to claim 12, wherein said industrial wireless protocol is based on IEE802.15.4

15. A system according to claim 12, wherein said at least one sensor is attached to one of an inner ring or an outer ring of said bearing.

16. A system according to claim 12, wherein said at least one sensor configured to obtain data concerning one or more factors that influence the residual life of a bearing is configured to obtain said data during at least part of one of the following periods: during said bearing's manufacture, after said bearing's manufacture and before said bearing's use, during said bearing's use, during a period when the bearing is not in use, during the transportation of said bearing.

17. A system according to claim 12, wherein said data concerning one or more factors that influence the residual life of said bearing includes data concerning at least one of the magnitude and severity of at least one of the following: vibration, temperature, rolling contact force/stress, high frequency stress waves, lubricant condition, rolling surface damage, operating speed, load carried, lubrication conditions, humidity, exposure to moisture, exposure to ionic fluids, exposure to mechanical shocks, corrosion, fatigue damage, and wear.

18. A system according to claim 12, wherein said at least one identification sensor includes a reader configured to obtain said identification data from a machine-readable identifier associated with said bearing.

19. A system according to claim 12, wherein said data processing unit is configured to record said data electronically.

20. A system according to claim 12, further comprising a prediction unit configured to predict the residual life of said bearing using said recorded data and a mathematical residual life predication model.

21. A system according to claim 12, wherein said bearing is a rolling element bearing.
